(19) United States
(12) Patent Application Publication
(10) Pub. No.: US 2025/0387934 A1
(43) Pub. Date: Dec. 25, 2025

(54) ELECTRIC SHAVER WITH ROTATABLE EXTERNAL CUTTING MEMBER HAVING V-SHAPED HAIR-ENTRY OPENINGS

(71) Applicant: KONINKLIJKE PHILIPS N.V., EINDHOVEN (NL)

(72) Inventors: SALMAN SHAFQAT, DRACHTEN (NL); MARTIJN DIRK KLEIN HORSMAN, KENMORE, WA (US); ROBBERT FREERK JOHAN VAN DER SCHEER, GRONINGEN (NL); ADRIANA ELIZABETH SCHOEMAN, DRACHTEN (NL); MARTINUS BARNARDUS STAPELBROEK, FRIESCHEPALEN (NL); WILLEM AUKE WESTERHOF, DRACHTEN (NL)

(21) Appl. No.: 18/878,136

(22) PCT Filed: Jun. 15, 2023
(86) PCT No.: PCT/EP2023/066155

§ 371 Date: Dec. 23, 2024

(30) Foreign Application Priority Data
Jun. 23, 2022 (EP) 22180647.4

(51) Int. Cl. B26B 19/14; B26B 19/28

(52) U.S. Cl. CPC B26B 19/143; B26B 19/28

(57) ABSTRACT

An electric shaver (1) comprises at least one hair-cutting unit (9a, 9b, 9c) having a central axis (11), an external cutting member (13) with hair-entry openings (61), and an internal cutting member (15). The internal and external cutting members are rotated about the central axis, respectively, in a first rotational direction (R1) and at a first rotational speed (ω1) and in a second rotational direction (R2) opposite to the first rotational direction and at a second rotational speed (ω2) lower than the first rotational speed. The hair-entry openings comprise a V-shaped opening portion (63) pointing opposite to the second rotational direction (R2). A tangential speed (VT) of the external cutting member relative to the central axis (11), measured in a radial position (RC) of a central base point (65) of the V-shaped opening portions, is in a range between 7.5 and 50 cm/s.

### FIELD OF THE INVENTION

The invention relates to an electric shaver comprising:
at least one hair-cutting unit having a central axis, an external cutting member having hair-entry openings provided in an annular shaving area arranged concentrically about the central axis, and an internal cutting member covered by the external cutting member and having an annular array of cutting elements arranged concentrically about the central axis; and
a drive system configured to rotate the internal cutting member of each hair-cutting unit about the central axis of the hair-cutting unit in a first rotational direction and at a first rotational speed and to rotate the external cutting member of each hair-cutting unit about the central axis of the hair-cutting unit in a second rotational direction opposite to the first rotational direction and at a second rotational speed which is lower than the first rotational speed.

### BACKGROUND OF THE INVENTION

Electric shavers comprising at least one hair-cutting unit having a central axis, an external cutting member having hair-entry openings provided in an annular shaving area arranged concentrically about the central axis, and an internal cutting member covered by the external cutting member and having an annular array of cutting elements arranged concentrically about the central axis, and further comprising a drive system configured to rotate the internal cutting member of each hair-cutting unit relative to the external cutting member about the central axis of the hair-cutting unit, are well known. Such electric shavers usually comprise a shaving unit with two or more of such hair-cutting units supported by a supporting structure of the shaving unit. The electric shavers usually comprise a main housing accommodating an electric motor. The shaving unit may be coupled to the main housing in a permanent way or in a releasable way. When the shaving unit is coupled to the main housing, the motor is coupled to the internal cutting members of the hair-cutting units via a transmission system allowing the motor to rotate the internal cutting members relative to the external cutting members. During rotation of the internal cutting members, hairs penetrate into the external cutting members via the hair-entry openings of the external cutting members and are cut by interaction of cutting edges provided on the cutting elements of the rotating internal cutting members and counter cutting edges provided at the hair-entry openings of the external cutting members.

An important property of the hair-cutting units of such electric shavers is the hair-catching efficiency, i.e., the degree at which hairs are able to penetrate into the hair-entry openings of the external cutting members during movement of the electric shaver over a user's skin with the annular shaving areas of the external cutting members in contact with the skin. A high hair-catching efficiency is desirable, because it will reduce the time of the shaving process required to achieve a desired shaving result, e.g., in terms of an average remaining hair length after the shaving process. The higher the hair-catching efficiency, the better the hairs will penetrate into the hair-entry openings of the external cutting members and be cut by the hair-cutting units, e.g., during a single movement stroke of the electric shaver over a particular area of the skin, and the smaller will be the resulting average remaining hair length after the shaving process. To improve the hair-catching efficiency, it has been proposed to also drive the external cutting members of the hair-cutting units into rotation about the central axes of the hair-cutting units. In particular, for this purpose it has been proposed to rotate the external cutting members in a rotational direction opposite to the rotational direction of the internal cutting members and at a rotational speed (in revolutions per unit of time) significantly lower than the rotational speed (in revolutions per unit of time) of the internal cutting members. For this purpose, known electric shavers have a drive system configured to rotate the internal cutting member of each hair-cutting unit about the central axis of the hair-cutting unit in a first rotational direction and at a first rotational speed and to rotate the external cutting member of each hair-cutting unit about the central axis of the hair-cutting unit in a second rotational direction opposite to the first rotational direction and at a second rotational speed which is lower than the first rotational speed. Examples of such known electric shavers are disclosed in the following prior art.

U.S. Pat. No. 2,283,834 discloses an electric shaver comprising a hair-cutting unit having an external cutting member provided with slit-shaped hair-entry openings that extend substantially radially with respect to the central axis of the hair-cutting unit. The hair-cutting unit has an internal cutting member which is rotated at a relatively high speed, e.g., between 6,000 and 15,000 rpm. The external cutting member is rotated in a direction opposite to the rotational direction of the internal cutting member at a significantly lower speed in a range between 40 and 120 rpm, preferably about 80 rpm. According to this patent, the relatively slow and continuous rotation of the external cutting member causes oblique hairs, which grow in various directions, to be caught better and more regularly in the slit-shaped hair-entry openings than would be possible by means of a circular manual movement of a shaver having a stationary external cutting member.

U.S. Pat. No. 10,195,751 B2 discloses an electric shaver comprising a shaving unit having three hair-cutting units. The hair-cutting units each have an internal cutting member and an external cutting member provided with slit-shaped hair-entry openings that extend radially with respect to the central axis of the hair-cutting unit, round hair-entry openings, or hair-entry openings having a combined round and slit shape. The internal cutting member and the external cutting member of each hair-cutting unit are rotatably driven in mutually opposite directions about a central axis of the hair-cutting unit. According to this patent, the rotation of the external cutting members results in an advantageous effect of a more favorable sensation to the skin by improving a user's action for raising and catching the hairs. In an example, the shaver has a gear transmission mechanism configured to convert a motor rotation speed of 8,000 rpm into a rotation speed of the external cutting member of approximately 10 rpm.

U.S. Pat. No. 6,901,662 B1 discloses an electric shaver comprising a shaving unit having three hair-cutting units. The hair-cutting units each have an internal cutting member and an external cutting member provided with hair-entry openings in the form of slots or hole perforations. The internal cutting member and the external cutting member of each hair-cutting unit are rotated in mutually opposite directions about a central axis of the hair-cutting unit. In addition, the three hair-cutting units are mounted on a common supporting frame which is rotated about a central axis of the shaving unit relative to a stationary shaver body. According to this patent, the combined rotations of the external cutting members about the central axes of the hair-cutting units and of the hair-cutting units about the central axis of the shaving unit results in forcing all hair ends upright and into the slots or hole perforations of the external cutting members. The rotation speed of the external cutting members is approximately twice the rotation speed of the common supporting frame onto which the hair-cutting units are mounted. In particular, the rotation speed of the external cutting members is in a range between 2 and 10 revolutions per second (120-600 rpm), and the rotation speed of the common supporting frame is in a range between 1 and 5 revolutions per second (60-300 rpm). The combined rotations of the internal and external cutting members about the central axes of the hair-cutting units and of the hair-cutting units about the central axis of the shaving unit however require a complex and bulky drive system.

### SUMMARY OF THE INVENTION

It is an object of the present invention to provide an electric shaver of a kind as described here before in the section “field of the invention” that has a significantly improved hair-catching efficiency as compared with at least the electric shavers known from U.S. Pat. Nos. 2,283,834 and 10,195,751 described here before, however without requiring an additional rotational motion of the hair-cutting units about the central axis of the shaving unit as proposed by U.S. Pat. No. 6,901,662 B1 described here before.

To achieve the above-mentioned object, the present invention provides an electric shaver comprising:
at least one hair-cutting unit having a central axis, an external cutting member having hair-entry openings provided in an annular shaving area arranged concentrically about the central axis, and an internal cutting member covered by the external cutting member and having an annular array of cutting elements arranged concentrically about the central axis; and
a drive system configured to rotate the internal cutting member of each hair-cutting unit about the central axis of the hair-cutting unit in a first rotational direction and at a first rotational speed and to rotate the external cutting member of each hair-cutting unit about the central axis of the hair-cutting unit in a second rotational direction opposite to the first rotational direction and at a second rotational speed which is lower than the first rotational speed;
   wherein:
the hair-entry openings of the external cutting member of each hair-cutting unit comprise a V-shaped opening portion pointing in the first rotational direction of the internal cutting member; and
the second rotational speed of the external cutting member of each hair-cutting unit is such that a tangential speed of the external cutting member relative to the central axis, measured in a radial position of a central base point of the V-shaped opening portions relative to the central axis, is in a range between 7.5 and 50 cm/s.

Thus, in an electric shaver according to the present invention the internal cutting member and the external cutting member of each hair-cutting unit are rotated by the drive system in mutually opposite directions about the central axis of the hair-cutting unit, wherein a second rotational speed of the external cutting member (in revolutions per unit of time) is lower than a first rotational speed of the internal cutting member (in revolutions per unit of time). In particular, according to the present invention, the hair-entry openings of the external cutting members comprise a V-shaped opening portion that points in the first rotational direction of the internal cutting member, i.e., in a direction opposite to the second rotational direction of the external cutting member. Furthermore, the second rotational speed of the external cutting members is such that a tangential speed of the external cutting member relative to the central axis, measured in a radial position of a central base point of the V-shaped opening portions relative to the central axis, is in a range between 7.5 and 50 cm/s. With respect to a V-shaped opening portion, the term “central base point” refers to a point where the two leg portions of the V-shaped opening portion mutually connect.

Experiments performed by the inventors of the present invention confirmed that, for a prior art hair-cutting unit having an external cutting member with straight slot-shaped hair-entry openings extending substantially in radial directions relative to the central axis of the hair-cutting unit, an increase of the hair-catching efficiency and, as a result, a reduction of the average remaining hair length after the shaving process are achieved by rotating the external cutting member in a direction opposite to the rotational direction of the internal cutting member. Said increase of the hair-catching efficiency and the resulting reduction of the average remaining hair length were however found to be relatively small and even not perceivable by the user. The experiments further demonstrated that, for a hair-cutting unit having an external cutting member having hair-entry openings with V-shaped opening portions pointing in the first rotational direction of the internal cutting member, a very significant increase of the hair-catching efficiency and, as a result, a very significant and user perceivable reduction of the average remaining hair length after the shaving process are achieved by rotating the external cutting member in a direction opposite to the rotational direction of the internal cutting member with a second rotational speed such that said tangential speed of the external cutting member relative to the central axis is in said range between 7.5 and 50 cm/s. In particular and surprisingly, a relative increase of the hair-catching efficiency and a relative reduction of the average remaining hair length as a result of the rotation of the external cutting member, i.e., relative to the hair-catching efficiency and the average remaining hair length achieved with a stationary external cutting member, were found to be significantly higher for an electric shaver according to the invention than for an electric shaver with an external cutting member with straight radially extending hair-entry openings.

In an embodiment of the electric shaver according to the invention, the second rotational speed of the external cutting member of each hair-cutting unit is such that said tangential speed of the external cutting member relative to the central axis is in a range between 11.25 and 30.0 cm/s. In this embodiment, the significant increase of the hair-catching efficiency and, as a result, the significant and user perceivable reduction of the average remaining hair length after the shaving process as described here before are achieved with a minimum degree of additional skin friction caused by the rotation of the external cutting member.

In a further embodiment of the electric shaver according to the invention, the hair-entry openings of the external cutting member of each hair-cutting unit further comprise a radially inner straight opening portion, connected to the V-shaped opening portion at a first end of the V-shaped opening portion facing the central axis of the hair-cutting unit, and a radially outer straight opening portion, connected to the V-shaped opening portion at a second end of the V-shaped opening portion facing away from the central axis of the hair-cutting unit, said radially inner and outer straight opening portions each having a main direction of extension in a radial direction relative to the central axis of the hair-cutting unit. In this embodiment, the radially inner straight opening portions and the radially outer straight opening portions of the hair-entry openings provide a relatively high hair-catching efficiency for hairs that approach the hair-entry openings of the external cutting member via, respectively, an inner circumferential area of the annular shaving area and an outer circumferential area of the annular shaving area. The V-shaped opening portions of the hair-entry openings provide a relatively high hair-catching efficiency for hairs that approach the hair-entry openings via a central area of the annular shaving area.

A particularly remarkable improvement of the hair-catching efficiency is achieved in an embodiment of the electric shaver according to the invention, wherein the hair-entry openings extend over a first radial distance in a radial direction relative to the central axis of the hair-cutting unit, and the V-shaped opening portions of the hair-entry openings extend over a second radial distance in the radial direction, said second radial distance being at least 50% of said first radial distance.

In a preferred embodiment of the electric shaver according to the invention, a V-angle of the V-shaped opening portions of the hair-entry openings is in a range from 60° to 135°. In this embodiment, with respect to a V-shaped opening portion the V-angle is defined as an angle enclosed by the two leg portions of the V-shaped opening portions. A V-angle in the range from 60° to 135° provides a stretching effect on the skin in two mutually diverging directions, which results in a reduction of skin doming into the hair-entry openings and, thereby, in a reduction of skin irritation caused by the shaving process.

In a further embodiment of the electric shaver according to the invention, the cutting elements of the internal cutting member of each hair-cutting unit comprise a cutting edge having a V-shaped cutting edge portion pointing in the second rotational direction of the external cutting member, said V-shaped cutting edge portions and the V-shaped opening portions of the hair-entry openings of the external cutting member being aligned in a tangential direction relative to the central axis of the hair-cutting unit. Thus, in this embodiment the V-shaped opening portions of the hair-entry openings of the external cutting member and the V-shaped cutting edge portions of the cutting elements of the internal cutting member point in mutually opposite directions. In this embodiment, skin irritation caused by the shaving process is further reduced as a result of the fact that, by the interaction of the V-shaped opening portions of the hair-entry openings of the external cutting member and the V-shaped cutting edge portions of the cutting elements of the internal cutting member, hairs caught by the hair-entry openings are mainly cut in the central areas of the V-shaped opening portions where the degree of skin doming into the hair-entry openings is at a minimum level. It is noted that, in this embodiment of the electric shaver according to the invention, the benefits of the present invention in terms of improvement of the hair-catching efficiency are effectively combined with the benefits of improvement of the shaving comfort, i.e., reduction of skin irritation provided by the shaving unit known from WO 2013/104965 A1 in the name of the applicant. The invention however also covers embodiments wherein the cutting edges of the cutting elements have a more conventional shape, such as a substantially straight shape or a slightly curved shape, each with a main direction of extension in the radial direction.

Because the influence of the first rotational speed of the internal cutting member on the hair-catching efficiency of the hair-cutting unit is limited as long as the first rotational speed is within a usual range applied in electric shavers of the rotary type, the first rotational speed of the internal cutting member of each hair-cutting unit of the electric shaver according to the invention may be such that a tangential speed of the internal cutting member relative to the central axis, measured at a radial distance from the central axis equal to a radial distance from the central axis at which the radial position of the central base point of the V-shaped opening portions is located, is in a range between 70 and 375 cm/s, more preferably in a range between 140 and 250 cm/s.

In an embodiment of the electric shaver according to the invention, the drive system comprises a single motor configured and arranged to rotate both the internal cutting member of each hair-cutting unit and the external cutting member of each hair-cutting unit about the central axis of each hair-cutting unit via a transmission system. The use of a single motor will simplify the structure of the electric shaver. The motor may be arranged in a main housing of the shaver, the at least one hair-cutting unit may be arranged in a shaving unit of the shaver which is coupled to the main housing, and the transmission system may be partially arranged in the main housing and partially arranged in the shaving unit. Alternatively to a single motor, the drive system might have a first motor to rotate the internal cutting member of each hair-cutting unit and a second motor to rotate the external cutting member of each hair-cutting unit independently from the rotation of the internal cutting member. In this alternative embodiment, the electric shaver might for example have a user input member by means of which the user can select the second rotational speed of the external cutting member independently from the first rotational speed of the internal cutting member, or switch on or off the rotation of the external cutting member independently from the rotation of the internal cutting member.

The above-described and other aspects of the invention will be apparent from and elucidated with reference to the following detailed description of embodiments of an electric shaver in accordance with the invention.

### BRIEF DESCRIPTION OF THE DRAWINGS

The invention will be explained in greater detail with reference to the figures, in which equal or similar features are indicated by the same reference signs, and in which:

FIG. 1 schematically shows an electric shaver according to the invention;

FIG. 2 is a schematic cross-sectional view of a hair-cutting unit of the electric shaver along the line II-II in FIG. 1;

FIG. 3 schematically shows a drive system of the electric shaver of FIG. 1;

FIG. 4a is a top view of a shaving unit of the electric shaver of FIG. 1;

FIG. 4b shows a portion of the drive system of FIG. 3;

FIG. 5 is a top view of an external cutting member of the hair-cutting unit of FIG. 2;

FIGS. 6a and 6b show graphs of the hair-catching efficiency of an external cutting member with straight hair-entry openings and the external cutting member of FIG. 5 as a function of a rotational speed of the external cutting member;

FIGS. 7a and 7b show graphs of the shaving efficiency of a hair-cutting unit having an external cutting member with straight hair-entry openings and the hair-cutting unit of FIG. 2 as a function of a rotational speed of the external cutting member of the hair-cutting unit; and

FIG. 8 shows an internal cutting member of the hair-cutting unit of FIG. 2.

### DETAILED DESCRIPTION OF THE EMBODIMENTS

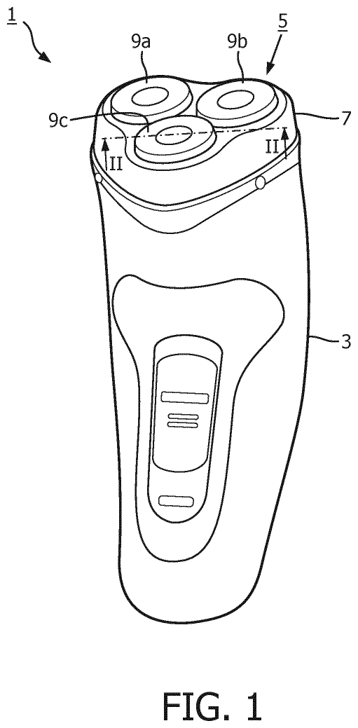

FIG. 1 schematically shows an embodiment of an electric shaver 1 according to the invention. The electric shaver 1 comprises a main housing 3 designed to be held by a user's hand during operation. The shaving device 1 further comprises a shaving unit 5 which is coupled to the main housing 3. The shaving unit 5 comprises a supporting structure 7 and three hair-cutting units 9a, 9b, 9c supported by the supporting structure 7. The supporting structure 7 may comprise a coupling structure, not shown in FIG. 1 and of a kind well known to the skilled person, by means of which the shaving unit 5 is releasably coupled to the main housing 3. Alternatively, the shaving unit 5 may be permanently connected to the main housing 3. It is noted that a shaving unit of an electric shaver according to the invention may comprise a different number of hair-cutting units, for example one, two or more than three hair-cutting units. It is further noted that FIG. 1 merely shows the general layout of the electric shaver in a schematic manner and does not intend to limit the scope of the invention to the specific detailed design of the electric shaver as shown. For example, the invention also covers embodiments of an electric shaver wherein the shaving unit is coupled to the main housing via a relatively narrow centrally arranged coupling structure, with an open space being present between the shaving unit and the main housing around said coupling structure, as is well known in the art.

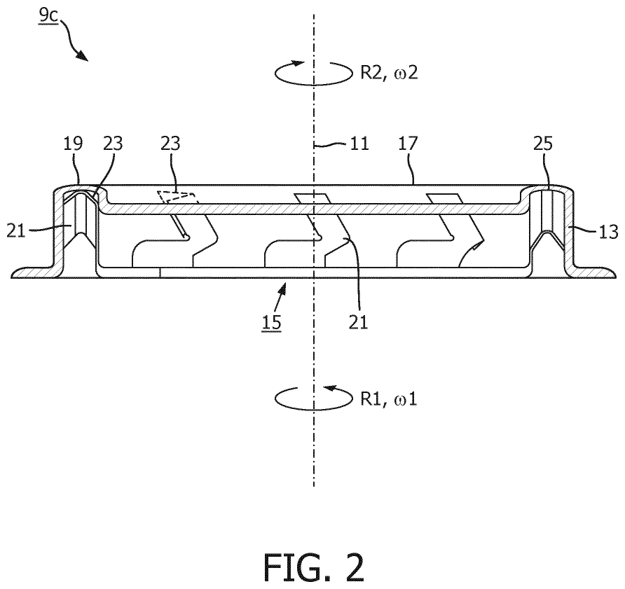

FIG. 2 is a schematic cross-sectional view of the hair-cutting unit 9c along the line II-II in FIG. 1. The hair-cutting units 9a and 9b are similar to the hair-cutting unit 9c. The hair-cutting unit 9c comprises a central axis 11, an external cutting member 13 and an internal cutting member 15. The external cutting member 13 has an annular shaving area 17 arranged concentrically about the central axis 11. The annular shaving area 17 is arranged to be in contact with the skin of a user of the electric shaver 1 and comprises hair-entry openings (not visible in FIG. 2) that will be described in detail here after. The hair-entry openings are mutually separated by bridge portions 19 provided in the annular shaving area 17. The internal cutting member 15 is covered by the external cutting member 13 and has an annular array of cutting elements 21 arranged concentrically about the central axis 11. The electric shaver 1 comprises a drive system, to be described in detail here after, configured to rotate the internal cutting member 15 and the external cutting member 13 relative to each other about the central axis 11 during operation of the electric shaver 1. As a result of the mutual rotations of the internal cutting member 15 and the external cutting member 13, hairs on the user's skin that penetrate into the hair-entry openings present in the annular shaving area 17 are cut by interaction of cutting edges 23 present on the cutting elements 21 of the internal cutting member 15 and counter cutting edges 25 present on the bridge portions 19 of the external cutting member 13. It is noted that an electric shaver according to the invention may have two or more annular shaving areas arranged concentrically about the central axis, as is known in the art.

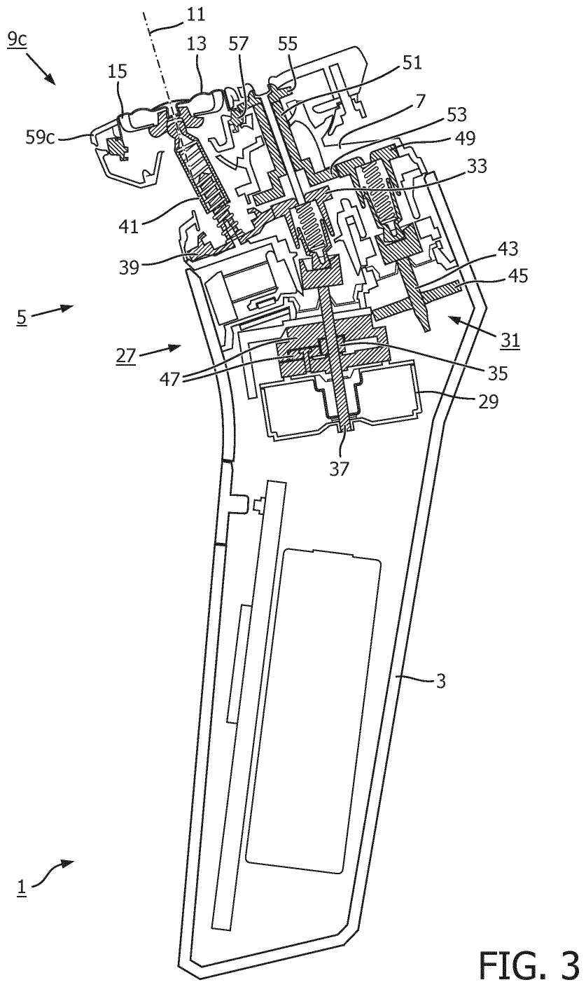

The drive system of the electric shaver 1 mentioned here before is schematically shown in FIG. 3 and is referred to by reference number 27. In the embodiment shown in FIG. 3, the drive system 27 comprises a single motor 29 which is arranged in the main housing 3. According to the invention, the drive system 27 is configured to rotate the internal cutting member 15 of each hair-cutting unit 9a, 9b, 9c about the central axis 11 of the hair-cutting unit 9a, 9b, 9c in a first rotational direction R1 (shown in FIG. 2) and at a first rotational speed ω1 and to rotate the external cutting member 13 of each hair-cutting unit 9a, 9b, 9c about the central axis 11 of the hair-cutting unit 9a, 9b, 9c in a second rotational direction R2 (shown in FIG. 2) opposite to the first rotational direction R1 and at a second rotational speed ω2 which is lower than the first rotational speed ω1. For this purpose, the drive system 27 comprises a transmission system 31 via which the motor 29 is able to rotate both the internal cutting member 15 and the external cutting member 13 of each hair-cutting unit 9a, 9b, 9c, wherein the transmission system 31 is partially arranged in the main housing 3 and partially arranged in the shaving unit 5. It is noted that, for simplicity reasons, FIG. 3 only shows one of the hair-cutting units 9c in detail. The driving of the other hair-cutting units 9a, 9b by the drive system 27 will be explained in the following. It is further noted that, for simplicity reasons, FIG. 3 does only partially show the supporting structure 7 of the shaving unit 5.

As shown in FIG. 3, the transmission system 31 comprises a first primary gear wheel 33 and a second primary gear wheel 35 which are each mounted to a motor shaft 37 of the motor 29. The transmission system 31 further comprises three secondary gear wheels 39 which are each mounted to a respective one of three drive spindles 41, which are each coupled to a respective one of the three internal cutting members 15 of the hair-cutting units 9a, 9b, 9c and are each rotatably journaled relative to the supporting structure 7 of the shaving unit 5. The three secondary gear wheels 39 each engage the first primary gear wheel 33. It is noted that FIG. 3 only shows one of the secondary gear wheels 39 and one of the drive spindles 41 coupled to the internal cutting member 15 of the hair-cutting unit 9c, and that the secondary gear wheels and the drive spindles associated with the internal cutting members 15 of the hair-cutting units 9a and 9b are arranged in a corresponding manner.

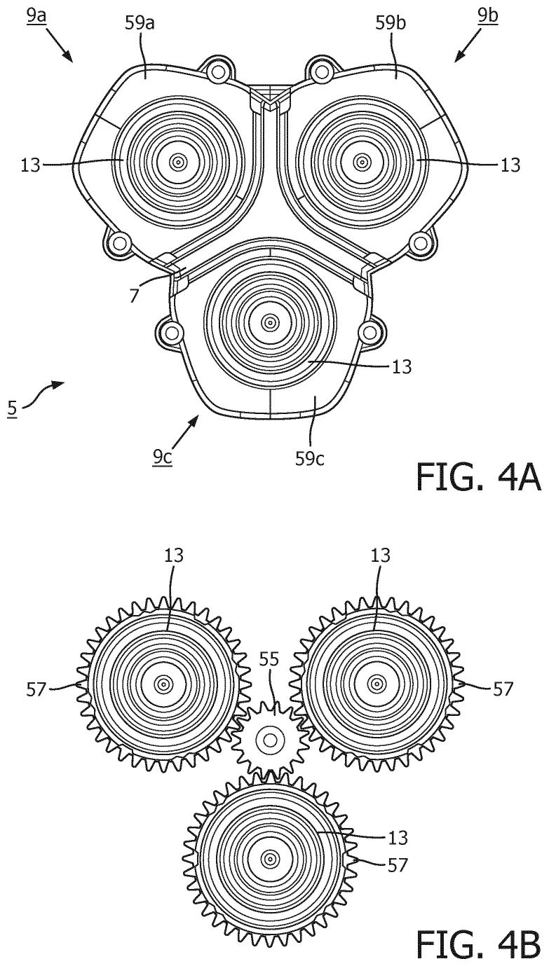

The transmission system 31 further comprises a secondary shaft 43 which is arranged parallel to the motor shaft 37. An upper portion of the secondary shaft 43 is arranged between two of the secondary gear wheels 39, but said arrangement is not visible in FIG. 3. The secondary shaft 43 carries a third primary gear wheel 45, which engages the second primary gear wheel 35 via a plurality of intermediate gear wheels 47, and a fourth primary gear wheel 49. The transmission system 31 further comprises a third shaft 51 which is arranged in line with the motor shaft 37 and which is rotatably journaled relative to the supporting structure 7 of the shaving unit 5. The third shaft 51 carries a fifth primary gear wheel 53, which engages the fourth primary gear wheel 49, and a sixth primary gear wheel 55. The external cutting members 13 of the hair-cutting units 9a, 9b, 9c each comprise a secondary gear wheel 57 which engages the sixth primary gear wheel 55 which is arranged centrally between the secondary gear wheels 57 of the external cutting members 13. It is noted that FIG. 3 only shows the secondary gear wheel 57 of the external cutting member 13 of the hair-cutting unit 9c, and that the secondary gear wheels 57 of the external cutting members 13 of the hair-cutting units 9a and 9b are arranged in a corresponding manner. For clarity reasons, the arrangement of the secondary gear wheels 57 of the external cutting members 13 of all three hair-cutting units 9a, 9b, 9c is shown in FIG. 4b. FIG. 4a shows that the external cutting members 13 are each surrounded by a skin-supporting member 59a, 59b, 59c of the respective hair-cutting unit 9a, 9b, 9c. The skin-supporting members 59a, 59b, 59c each provide a rotational bearing for the respective external cutting member 13 and also cover the secondary gear wheel 57 of the respective external cutting member 13.

It is noted that the drive system 27 as described in detail here before is only an example of how the drive system in an electric shaver according to the invention could be embodied. The skilled person will be able to design alternative embodiments of a drive system by means of which, in accordance with the invention, the internal cutting member 15 and the external cutting member 13 of each hair-cutting unit 9a, 9b, 9c can be rotated in the mutually opposite directions R1, R2 about the central axis, wherein the second rotational speed ω2 of the external cutting member 13 is lower than the first rotational speed ω1 of the internal cutting member 15. Instead of the single motor 29, the drive system 27 may have a first motor to rotate the internal cutting member 15 of each hair-cutting unit 9a, 9b, 9c and a second motor to rotate the external cutting member 13 of each hair-cutting unit 9a, 9b, 9c independently from the rotation of the internal cutting members 15. In this alternative embodiment, the electric shaver 1 might for example have a user input member by means of which the user can select the second rotational speed ω2 of the external cutting members 13 independently from the first rotational speed ω1 of the internal cutting members 15, or switch on or off the rotation of the external cutting members 13 independently from the rotation of the internal cutting members 15.

From prior art electric shavers it is known that the hair-catching efficiency of the hair-cutting units 9a, 9b, 9c is improved by the rotation of the external cutting member 13 of each hair-cutting unit 9a, 9b, 9c in the rotational direction R2 opposite to the rotational direction R1 of the internal cutting member 15 and at the rotational speed ω2 lower than the rotational speed ω1 of the internal cutting member 15. The hair-catching efficiency is the degree at which hairs are able to penetrate into the hair-entry openings of the external cutting members 13 during movement of the electric shaver 1 over the user's skin with the annular shaving areas 17 of the external cutting members 13 in contact with the skin. The higher the hair-catching efficiency, the better the hairs will penetrate into the hair-entry openings of the external cutting members 13 and be cut by the hair-cutting units 9a, 9b, 9c, e.g., during a single movement stroke of the electric shaver 1 over a particular area of the skin, and the smaller will be the resulting average remaining hair length after the single movement stroke.

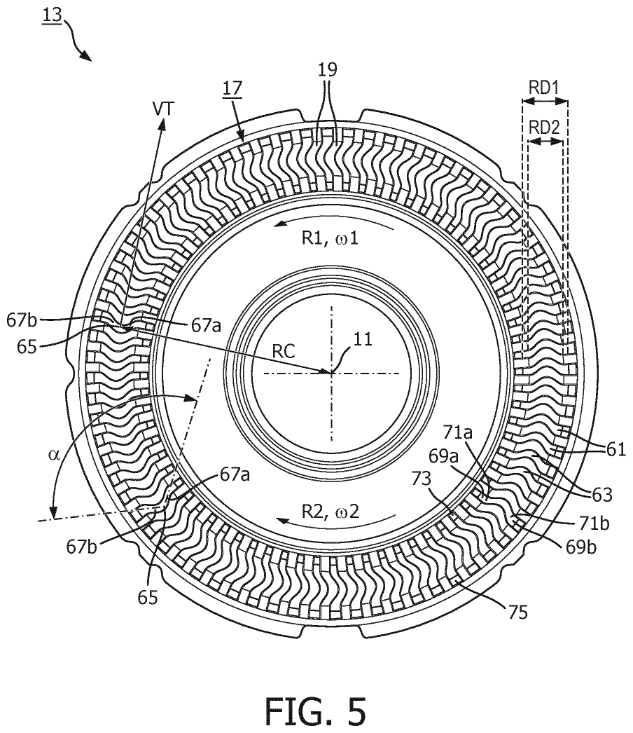

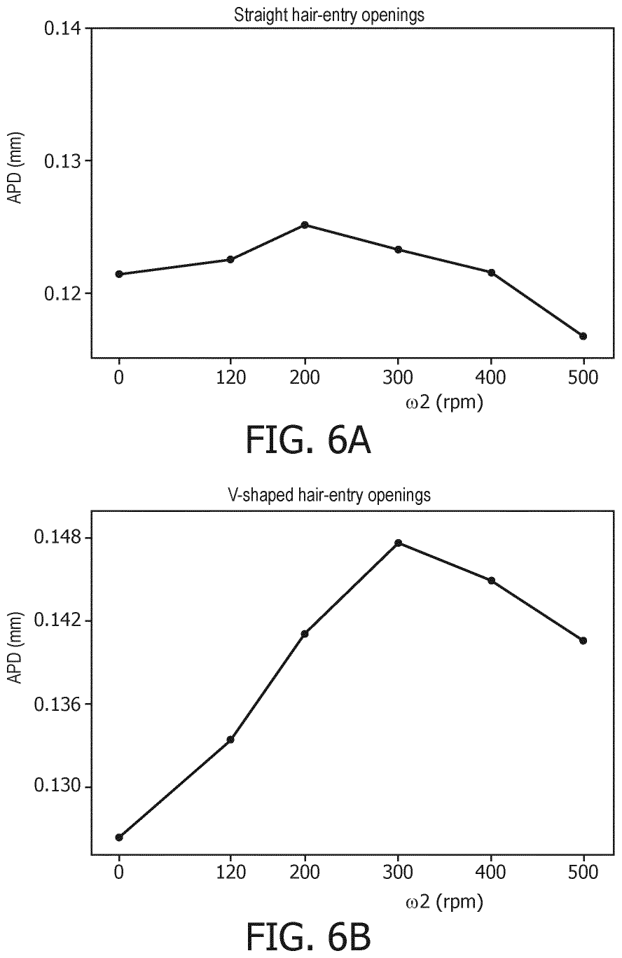

To further improve the hair-catching efficiency of the hair-cutting units 9a, 9b, 9c, according to the present invention the external cutting member 13 of each hair-cutting unit 9a, 9b, 9c of the electric shaver 1 has hair-entry openings 61 that comprise a V-shaped opening portion 63 pointing in the first rotational direction R1 of the internal cutting member 15, i.e., pointing in a direction opposite to the second rotational direction R2 of the external cutting member 13, as shown in FIG. 5. Furthermore, in accordance with the invention the second rotational speed ω2 of the external cutting member 13 of each hair-cutting unit 9a, 9b, 9c is such that a tangential speed VT of the external cutting member 13 relative to the central axis 11 of the hair-cutting unit 9a, 9b, 9c is in a range between 7.5 and 50 cm/s. In this respect, said tangential speed VT is to be measured in a radial position RC of a central base point 65 of the V-shaped opening portions 63 relative to the central axis 11, as shown in FIG. 5. The central base point 65 is a point of the V-shaped opening portion 63 where the two leg portions 67a, 67b of the V-shaped opening portion 63 mutually connect, as also shown in FIG. 5. Thus, VT=2π*RC*ω2, and ω2=VT/(2π*RC). The inventors of the present invention have performed experiments in the form of numerical simulations using a mathematical model of the human skin with hairs, a mathematical model of a hair-cutting unit having an external cutting member with straight slot-shaped hair-entry openings extending substantially in radial directions relative to the central axis of the hair-cutting unit, and a mathematical model of the hair-cutting unit 9a, 9b, 9c. FIGS. 6a and 6b show graphs of the hair-catching efficiency of, respectively, the external cutting member with the straight hair-entry openings and the external cutting member 13 as a function of the second rotational speed ω2 (in rpm). In these figures, the hair-catching efficiency is expressed as an average penetration depth APD (in mm) of the hairs into the hair-entry openings of the respective external cutting members. The simulations were done for a uniform hair length of 1 mm and for a plurality of single strokes of the respective external cutting member over a particular skin area at stroke speeds between 10 cm/s and 30 cm/s. For the external cutting member 13, the radial position RC of the central base points 65 of the V-shaped opening portions 63 relative to the central axis 11 is 9 mm. For the external cutting member with the straight hair-entry openings, a radial position of a central radial point of the straight hair-entry openings is also 9 mm. Accordingly, the value ω2=500 rpm in the graphs corresponds to a value VT=47 cm/s. The graphs show a comparable hair-catching efficiency (APD) of the external cutting member with the straight hair-entry openings and the external cutting member 13 in the absence of a rotational motion of the external cutting member (ω2=0). With rotation of the external cutting member, the hair-catching efficiency (APD) of the external cutting member with the straight hair-entry openings is slightly increased, with an optimum hair-catching efficiency being achieved for a rotational speed ω2 of about 200 rpm as shown in FIG. 6a. As shown in FIG. 6b, with rotation of the external cutting member 13 of the electric shaver 1 according to the invention the hair-catching efficiency (APD) of the external cutting member 13 is increased to a significantly larger extent as compared with the external cutting member with the straight hair-entry openings. As shown in FIG. 6b, for the external cutting member 13 an optimum hair-catching efficiency is achieved for a second rotational speed ω2 of about 300 rpm. In particular, as is clear from the FIGS. 6a and 6b, a relative increase of the hair-catching efficiency (APD) as a result of the rotation of the external cutting member, i.e., a ratio between the average penetration depths (APD) of the hairs into the hair-entry openings with and without rotation of the external cutting member, was found to be significantly higher for the external cutting member 13 of the electric shaver 1 according to the invention than for the external cutting member with the straight radially extending hair-entry openings.

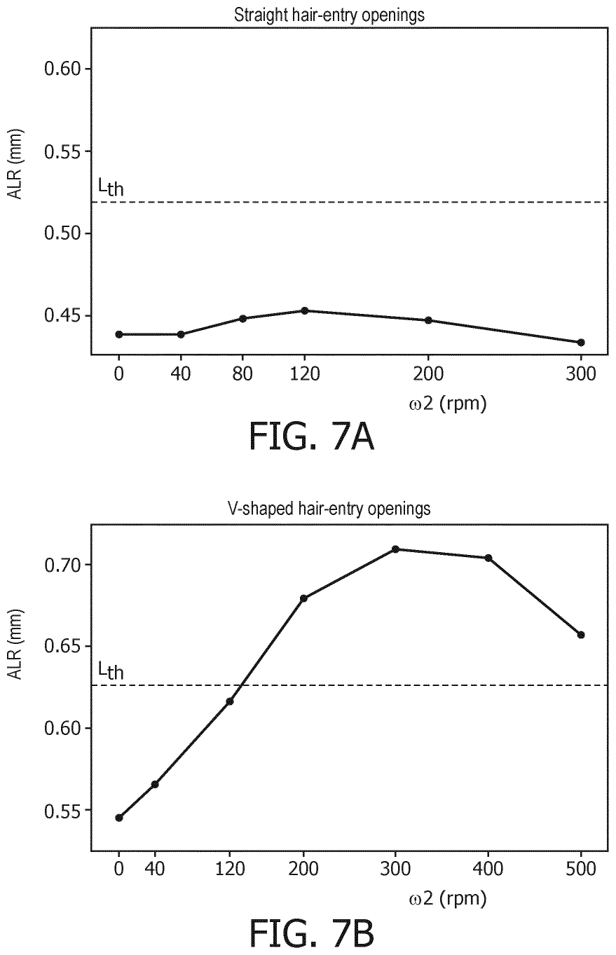

FIGS. 7a and 7b show graphs of the shaving efficiency of, respectively, the hair-cutting unit having the external cutting member with the straight hair-entry openings and the hair-cutting unit 9a, 9b, 9c as a function of the second rotational speed ω2 (in rpm). In these figures, the shaving efficiency is expressed as an average hair length reduction ALR (in mm) achieved by means of the respective hair-cutting units. The simulations were done for a uniform hair length of 1 mm and for a plurality of single strokes of the respective hair-cutting unit over a particular skin area at stroke speeds between 10 cm/s and 30 cm/s. For the external cutting member 13 of the hair-cutting unit 9a, 9b, 9c, the radial position RC of the central base points 65 of the V-shaped opening portions 63 relative to the central axis 11 is 9 mm. For the hair-cutting unit having the external cutting member with the straight hair-entry openings, a radial position of a central radial point of the straight hair-entry openings is also 9 mm. Accordingly, the value ω2=500 rpm in the graphs corresponds to a value VT=47 cm/s. The graphs show that, in the absence of a rotational motion of the external cutting member (ω2=0), the shaving efficiency (in terms of ALR) of the hair-cutting unit 9a, 9b, 9c is about 25% higher than the shaving efficiency of the hair-cutting unit having the external cutting member with the straight hair-entry openings. With rotation of the external cutting member, the shaving efficiency (ALR) of the hair-cutting unit having the external cutting member with the straight hair-entry openings is slightly increased, with an optimum shaving efficiency being achieved for a rotational speed ω2 of about 120 rpm as shown in FIG. 7a. As shown in FIG. 7b, with rotation of the external cutting member 13 of the hair-cutting unit 9a, 9b, 9c of the electric shaver 1 according to the invention the shaving efficiency (ALR) of the hair-cutting unit 9a, 9b, 9c is increased to a significantly larger extent as compared with the hair-cutting unit having the external cutting member with the straight hair-entry openings. As shown in FIG. 7b, for the hair-cutting unit 9a, 9b, 9c an optimum shaving efficiency is achieved for a second rotational speed ω2 of about 300 rpm. In particular, as is clear from the FIGS. 7a and 7b, a relative increase of the shaving efficiency (ALR) as a result of the rotation of the external cutting member, i.e., a ratio between the average hair length reduction (ALR) with and without rotation of the external cutting member, was found to be significantly higher for the hair-cutting unit 9a, 9b, 9c of the electric shaver 1 according to the invention than for the hair-cutting unit having the external cutting member with the straight radially extending hair-entry openings.

As can be derived from FIG. 7b, a significant increase of the shaving efficiency (ALR) of about 10% can already be achieved when the second rotational speed ω2 of the external cutting member 13 is about 80 rpm, corresponding to a value of VT of about 7.5 cm/s. As is clear from FIG. 7a, such a significant relative increase of the shaving efficiency (ALR) cannot be achieved by rotation of the external cutting member with the straight hair-entry openings. Furthermore, the line Lth in FIGS. 7a and 7b represents an increase of the shaving efficiency (ALR) that is considered to be particularly perceivable by the user of the electric shaver 1. For the external cutting member 13, such a particularly user-perceivable increase of the shaving efficiency (ALR) is achieved when the second rotational speed ω2 is between about 120 rpm (corresponding to VT=11.25 cm/s) and about 550 rpm (corresponding to VT=50 cm/s). Values of VT above 50 cm/s might not be preferred in view of the relatively high skin friction caused by the rotation of the external cutting member 13. Thus, in accordance with the invention, the second rotational speed ω2 of the external cutting member 13 is such that said tangential speed VT of the external cutting member 13, measured in the radial position RC of the central base points 65 of the V-shaped opening portions 63 of the hair-entry openings 61, is in the range between 7.5 cm/s and 50 cm/s, while a more preferred range for the value of VT is between 11.25 cm/s and 50 cm/s.

Furthermore, as shown in FIG. 7b, the relative increase of the shaving efficiency (ALR) in the range for the value of ω2 between about 120 rpm (VT=11.25 cm/s) and about 300 rpm (VT=28.3 cm/s) is comparable with the relative increase of the shaving efficiency (ALR) in the range for the value of ω2 between about 300 rpm (VT=28.3 cm/s) and about 550 rpm (VT=50 cm/s). Because the skin friction caused by the rotation of the external cutting member 13 is lower at lower values of VT, the range for the value of VT between 11.25 cm/s and 30.0 cm/s, according to an embodiment of the invention, provides a preferred combination of the significant increase of the hair-catching and shaving efficiencies as described here before and a minimum degree of additional skin friction caused by the rotation of the external cutting member 13.

Similar experiments, done for hair-cutting units having an external cutting member wherein the hair-entry openings, and in particular the V-shaped opening portions thereof, are arranged at larger or smaller radial distances from the central axis as compared to the radial distance RC of the external cutting member 13 as described here before, have shown that the ranges for the value of VT in accordance with the invention as described here before, within which the benefits of the present invention as described here before are achieved, are independent from said radial distance. In other words, in embodiments of the invention wherein the V-shaped opening portions 63 of the hair-entry openings 61 are arranged at a larger, respectively a smaller radial distance RC from the central axis 11, the second rotational speed ω2 of the external cutting member 13 should be decreased, respectively increased proportionally to said radial distance RC in order to achieve comparable results as regards improved hair-catching and shaving efficiencies. For example, where in the embodiment described here before the second rotational speed ω2 is about 300 rpm (with RC=9 mm), comparable results would be achieved at a second rotational speed ω2 of about 225 rpm in an embodiment wherein RC=12 mm, and at a second rotational speed ω2 of about 450 rpm in an embodiment wherein RC=6 mm.

As shown in FIG. 5, the hair-entry openings 61 of the external cutting member 13 each extend over a first radial distance RD1 in a radial direction relative to the central axis 11. The V-shaped opening portions 63 of the hair-entry openings 61 each extend over a second radial distance RD2 in the radial direction relative to the central axis 11. In the embodiment shown in FIG. 5, a ratio RD2/RD1 is about 0.75. A particularly significant improvement of the hair-catching and shaving efficiencies is achieved in embodiments of the electric shaver wherein said ratio RD2/RD1 is at least 0.5. Improvements of the hair-catching and shaving efficiencies may however also be achieved for smaller values of said ratio, in particular when the first radial distance RD1 over which the hair-entry openings 61 extend is relatively large.

In the embodiment shown in FIG. 5, the hair-entry openings 61 of the external cutting member 13 further comprise a radially inner straight opening portion 69a and a radially outer straight opening portion 69b. The radially inner straight opening portion 69a is connected to the V-shaped opening portion 63 of the hair-entry opening 61 at a first end 71a of the V-shaped opening portion 63 which faces the central axis 11. The radially outer straight opening portion 69b is connected to the V-shaped opening portion 63 at a second end 71b of the V-shaped opening portion 63 which faces away from the central axis 11. The radially inner and outer straight opening portions 69a, 69b each have a main direction of extension in a radial direction relative to the central axis 11. In this embodiment, the radially inner straight opening portions 69a provide a relatively high hair-catching efficiency for hairs that approach the hair-entry openings 61 of the external cutting member 13 via an inner circumferential area 73 of the annular shaving area 17 during random motion of the hair-cutting unit 9a, 9b, 9c over the user's skin. During such random motion, the radially outer straight opening portions 69b provide a relatively high hair-catching efficiency for hairs that approach the hair-entry openings 61 via an outer circumferential area 75 of the annular shaving area 17, while the V-shaped opening portions 63 provide a relatively high hair-catching efficiency for hairs that approach the hair-entry openings 61 via a central area of the annular shaving area 17.

Furthermore, FIG. 5 shows a V-angle α of the V-shaped opening portions 63 of the hair-entry openings 61, which is defined as the angle enclosed by the two leg portions 67a, 67b of the V-shaped opening portions 63. In the embodiment shown in FIG. 5, the V-angle α is about 115°. A preferred range for the V-angle α is the range from 60° to 135°. With a value of the V-angle α in this preferred range, the V-shaped opening portions 63 provide, in addition to the improved hair-catching and shaving efficiencies, a stretching effect on the skin in two mutually diverging directions during rotation of the external cutting member 13 in the second rotational direction R2. Said skin-stretching effect results in a reduction of skin doming into the hair-entry openings 61 and, thereby, in a reduction of skin irritation caused by the shaving process.

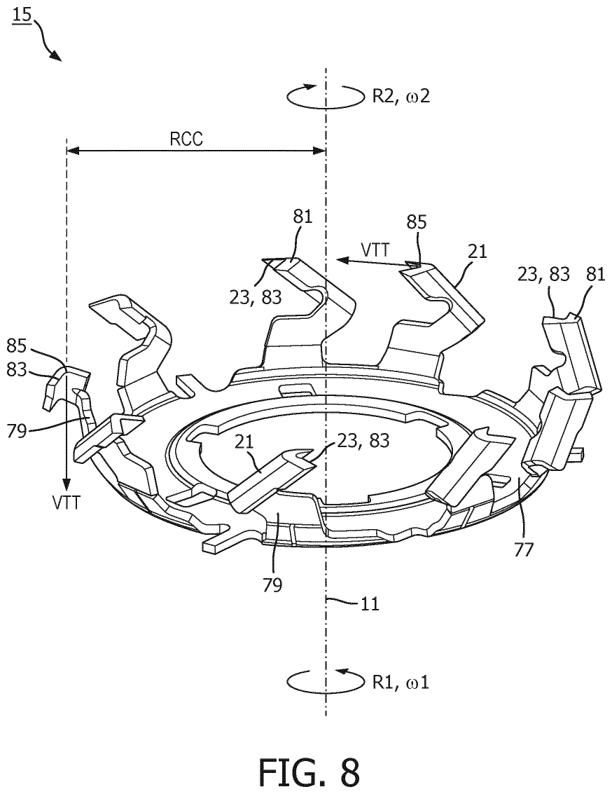

FIG. 8 shows the internal cutting member 15 of the hair-cutting unit 9a, 9b, 9c, the first rotational direction R1 of the internal cutting member 15 about the central axis 11 of the hair-cutting unit 9a, 9b, 9c, and the second rotational direction R2 of the external cutting member 13. Each cutting element 21 of the annular array of cutting elements 21 is connected to a carrier 77 of the internal cutting member 15 via a bent connecting element 79. The carrier 77, the cutting elements 21 and the bent connecting elements 79 may be integrally formed from a single metal plate in a manner known to the person skilled in the art. The cutting edge 23 of each cutting element 21 is provided on the leading or front edge (with respect to the first rotational direction R1) of an upper surface 81 of the cutting element 21. The carrier 77 is coupled to one of the three drive spindles 41 of the drive system 27, which is described here before, in a manner well known to the person skilled in the art. A coupling between the drive spindle 41 and the carrier 77 is therefore not shown in FIG. 8.

In the embodiment shown in FIG. 8, the cutting edges 23 of the cutting elements 21 of the internal cutting member 15 each comprise a V-shaped cutting edge portion 83 pointing in the second rotational direction R2 of the external cutting member 13, i.e., pointing in a direction opposite to the first rotational direction R1 of the internal cutting member 15 and opposite to the direction wherein the V-shaped opening portions 63 of the hair-entry openings 61 of the external cutting member 13 are pointing. In the embodiment shown in FIG. 8, the V-shaped cutting edge portions 83 each extend over the full extension of the cutting edge 23. The V-shaped cutting edge portions 83 of the cutting edges 23 of the internal cutting member 15 and the V-shaped opening portions 63 of the hair-entry openings 61 of the external cutting member 13 are aligned in a tangential direction relative to the central axis 11. Said alignment implies that a central base point 85 of each V-shaped cutting edge portion 83 is arranged at a radial distance RCC from the central axis 11 which is substantially equal to the radial position RC of the central base points 65 of the V-shaped opening portions 63 relative to the central axis 11. In this embodiment, skin irritation caused by the shaving process is further reduced as a result of the fact that, by the interaction of the V-shaped opening portions 63 of the hair-entry openings 61 of the external cutting member 13 and the V-shaped cutting edge portions 83 of the cutting elements 21 of the internal cutting member 15, hairs caught by the hair-entry openings 61 are mainly cut in the central areas of the V-shaped opening portions 63 where the degree of skin doming into the hair-entry openings 61 is at a minimum level. It is however noted that the invention also covers embodiments wherein the cutting edges 23 of the cutting elements 21 of the internal cutting member 15 have a more conventional shape, such as a substantially straight shape or a slightly curved shape, each with a main direction of extension in the radial direction.

The influence of the first rotational speed ω1 of the internal cutting member 15 on the hair-catching efficiency of the hair-cutting unit 9a, 9b, 9c is limited. The first rotational speed ω1 may therefore be selected mainly on the basis of the required hair-cutting efficiency of the cutting elements 21 of the rotating internal cutting member 15, as is known to the person skilled in the art. In the embodiment of FIG. 8, a preferred range of the first rotational speed ω1 is such that a tangential speed VTT of the cutting elements 21 of the internal cutting member 15 relative to the central axis 11, measured at the radial distance RCC from the central axis 11 as shown in FIG. 8, is in a range between 70 and 375 cm/s, more preferably in a range between 140 and 250 cm/s. In the present embodiment, wherein RCC=9 mm, said ranges of said tangential speed VTT correspond with ranges of the first rotational speed ω1 of, respectively, between about 750 and 4000 rpm and between about 1500 and 2700 rpm.

It will be clear to a person skilled in the art that the scope of the invention is not limited to the examples discussed in the foregoing, and that several amendments and modifications thereof are possible without deviating from the scope of the invention as defined in the attached claims. It is intended that the invention be construed as including all such amendments and modifications insofar they come within the scope of the claims or the equivalents thereof. While the invention has been illustrated and described in detail in the figures and the description, such illustration and description are to be considered illustrative or exemplary only, and not restrictive. The invention is not limited to the disclosed embodiments. The drawings are schematic, wherein details which are not required for understanding the invention may have been omitted, and may not necessarily be to scale.

Variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. Any reference signs in the claims should not be construed as limiting the scope of the invention.

Elements and aspects discussed for or in relation with a particular embodiment may be suitably combined with elements and aspects of other embodiments, unless explicitly stated otherwise. Thus, the mere fact that certain measures are recited in mutually different dependent claims does not indicate that a combination of these measures cannot be used to advantage.

1. Electric shaver (1) comprising:
at least one hair-cutting unit (9a, 9b, 9c) having a central axis (11), an external cutting member (13) having hair-entry openings (61) provided in an annular shaving area (17) arranged concentrically about the central axis, and an internal cutting member (15) covered by the external cutting member and having an annular array of cutting elements (21) arranged concentrically about the central axis; and
a drive system (27) configured to rotate the internal cutting member of each hair-cutting unit about the central axis of the hair-cutting unit in a first rotational direction (R1) and at a first rotational speed (ω1) and to rotate the external cutting member of each hair-cutting unit about the central axis of the hair-cutting unit in a second rotational direction (R2) opposite to the first rotational direction and at a second rotational speed (ω2) which is lower than the first rotational speed;
characterized in that:
the hair-entry openings (61) of the external cutting member (13) of each hair-cutting unit (9a, 9b, 9c) comprise a V-shaped opening portion (63) pointing in the first rotational direction (R1) of the internal cutting member (15); and
I the second rotational speed (ω2) of the external cutting member of each hair-cutting unit is such that a tangential speed (VT) of the external cutting member relative to the central axis (11), measured in a radial position (RC) of a central base point (65) of the V-shaped opening portions relative to the central axis, is in a range between 7.5 and 50 cm/s.

2. Electric shaver (1) as claimed in claim 1, wherein the second rotational speed (ω2) of the external cutting member (13) of each hair-cutting unit (9a, 9b, 9c) is such that said tangential speed (VT) of the external cutting member relative to the central axis (11) is in a range between 11.25 and 30.0 cm/s.

3. Electric shaver (1) as claimed in claim 1, wherein the hair-entry openings (61) of the external cutting member (13) of each hair-cutting unit (9a, 9b, 9c) further comprise a radially inner straight opening portion (69a), connected to the V-shaped opening portion (63) at a first end (71a) of the V-shaped opening portion facing the central axis (11) of the hair-cutting unit, and a radially outer straight opening portion (69b), connected to the V-shaped opening portion at a second end (71b) of the V-shaped opening portion facing away from the central axis of the hair-cutting unit, said radially inner and outer straight opening portions each having a main direction of extension in a radial direction relative to the central axis of the hair-cutting unit.

4. Electric shaver (1) as claimed in claim 1, wherein the hair-entry openings (61) extend over a first radial distance (RD1) in a radial direction relative to the central axis (11) of the hair-cutting unit (9a, 9b, 9c), and the V-shaped opening portions (63) of the hair-entry openings extend over a second radial distance (RD2) in the radial direction, said second radial distance being at least 50% of said first radial distance.

5. Electric shaver (1) as claimed in claim 1, wherein a V-angle (α) of the V-shaped opening portions (63) of the hair-entry openings (61) is in a range from 60° to 135°.

6. Electric shaver (1) as claimed in claim 1, any wherein the cutting elements (21) of the internal cutting member (15) of each hair-cutting unit (9a, 9b, 9c) comprise a cutting edge (23) having a V-shaped cutting edge portion (83) pointing in the second rotational direction (R2) of the external cutting member (13), said V-shaped cutting edge portions and the V-shaped opening portions (63) of the hair-entry openings (61) of the external cutting member being aligned in a tangential direction relative to the central axis (11) of the hair-cutting unit.

7. Electric shaver (1) as claimed in claim 1, wherein the first rotational speed (ω1) of the internal cutting member (15) of each hair-cutting unit (9a, 9b, 9c) is such that a tangential speed (VTT) of the internal cutting member relative to the central axis (11), measured at a radial distance (RCC) from the central axis equal to a radial distance from the central axis at which the radial position (RC) of the central base point (65) of the V-shaped opening portions (63) is located, is in a range between 70 and 375 cm/s, more preferably in a range between 140 and 250 cm/s.

8. Electric shaver as claimed in claim 1, wherein the drive system (27) comprises a single motor (29) configured and arranged to rotate both the internal cutting member (15) of each hair-cutting unit (9a, 9b, 9c) and the external cutting member (13) of each hair-cutting unit about the central axis (11) of the hair-cutting unit via a transmission system (31).

9. Electric shaver (1) as claimed in claim 8, wherein the motor (29) is arranged in a main housing (3) of the shaver, wherein the at least one hair-cutting unit (9a, 9b, 9c) is arranged in a shaving unit (5) of the shaver which is coupled to the main housing, and wherein the transmission system (31) is partially arranged in the main housing and partially arranged in the shaving unit.
